(19) United States
(12) Patent Application Publication
(10) Pub. No.: US 2014/0265912 A1
(43) Pub. Date: Sep. 18, 2014

(54) COIL COMPONENT AND ELECTRONIC DEVICE HAVING THE SAME

(71) Applicant: Samsung Electro-Mechanics CO., LTD., Suwon (KR)

(72) Inventors: Young Min Lee, Suwon (KR); Jong Woo Kim, Suwon (KR); Geun Young Park, Suwon (KR)

(73) Assignee: SAMSUNG ELECTRO-MECHANICS CO., LTD., Suwon (KR)

(21) Appl. No.: 13/947,496

(22) Filed: Jul. 22, 2013

(30) Foreign Application Priority Data
Mar. 14, 2013 (KR) 10-2013-0027529
May 27, 2013 (KR) 10-2013-0059886

(51) Int. Cl. H01F 27/24; H05B 33/08

(52) U.S. Cl. CPC H01F 27/24; H05B 33/0809
USPC 315/289; 336/212

(57) ABSTRACT

There is provided a coil component capable of minimizing mutual interference while disposing a plurality of coil parts in a single component. According to an embodiment of the present invention, the coil component includes: a bobbin part including two body parts disposed in parallel, the two body parts having coils wound therearound; and a core including two inner legs inserted into the body parts and two outer legs disposed outwardly of the body parts, the inner legs and the outer legs having the same cross sectional area.

### CROSS-REFERENCE TO RELATED APPLICATIONS

This application claims the priorities of Korean Patent Application Nos. 10-2013-0027529 filed on Mar. 14, 2013 and 10-2013-0059886 filed on May 27, 2013, in the Korean Intellectual Property Office, the disclosures of which are incorporated herein by reference.

### BACKGROUND OF THE INVENTION

1. Field of the Invention

The present invention relates to a coil component, and more particularly, to a coil component capable of minimizing mutual interference even in the case that a plurality of coil parts are disposed in a single component and an electronic device having the same.

2. Description of the Related Art

In general, a switching mode power supply (SMPS) is used as a power supply in display devices, printers, and other electric and electronic devices.

The SMPS is a module type power supply which converts externally supplied electricity into electricity appropriate for various electric and electronic devices, such as computers, TVs, VCRs, switchboards, wireless communications devices, and the like, and serves to control triggering for a frequency higher than a commercial frequency and alleviate impacts using semiconductor switching characteristics.

Recently, as TV screens have been increased in size, large amounts of power have been required in the operating thereof. To this end, the SMPS (for example, a DC-DC converter) needs to have a plurality of coil components mounted therein to turn back lighting of a large panel on.

In case of a non-isolation type step-up DC-DC converter mounted in the related art SMPS, the non-isolation type step-up DC-DC converter having one coil component mounted in a single converter circuit, has generally been used.

However, as the size of the panel is increased, a plurality of coil components may be mounted in the SMPS, such that the size of the SMPS may accordingly be increased. Further, when such a plurality of coil components is mounted on a substrate, a production rate may be relatively slow and manufacturing costs may be increased.

### RELATED ART DOCUMENT

(Patent Document 1) Korean Patent Laid-open Publication No. 10-2005-0007240

### SUMMARY OF THE INVENTION

An aspect of the present invention provides a coil component, unified by integrating a plurality of coil parts and an electronic device having the same.

Further, another aspect of the present invention provides a coil component capable of minimizing mutual interference even in the case that a plurality of coil parts are unified to forma single component and an electronic device having the same.

According to an aspect of the present invention, there is provided a coil component, including: a bobbin part including two body parts disposed in parallel, the two body parts having coils wound therearound; and a core including two inner legs inserted into the body parts and two outer legs disposed outwardly of the body parts, the inner legs and the outer legs having the same cross sectional area.

The core may have the inner legs and the outer legs disposed in parallel.

The core may include a connection part connecting the inner legs and the outer legs.

The connection part of the core may have the same cross sectional area as the inner leg and the outer leg.

The core may have a ‘ [symbol] ’-like shape.

The core may have a clearance formed between ends of the inner legs facing each other.

The bobbin part may be formed by coupling first and second bobbins to one another, the first and second bobbins having the same shape.

Each of the first and second bobbins may include the body part having a tubular shape, and terminal parts formed at both ends of the body part, and the body part may be disposed in a position toward one side of the terminal part.

The first and second bobbins may be coupled to each other to allow the body parts to be disposed adjacently thereto.

The core may be seated on an upper surface of the terminal part and coupled to the bobbin part.

The first and second bobbins may have at least one protrusion and at least one insertion part formed on the terminal parts, and be coupled to each other by inserting the at least one protrusion into the at least one insertion part.

The terminal parts may be provided with a plurality of external connection terminals fastened thereto.

According to another aspect of the present invention, there is provided a coil component, including: a core including two inner legs and two outer legs; and first and second coil parts respectively coupled to the inner legs, wherein the inner legs and the outer legs have the same cross sectional area.

According to another aspect of the present invention, there is provided a coil component, including: a first bobbin including a tubular body part and terminal parts formed at both ends of the body part and having a length greater than a diameter of the body part, the body part being disposed in a position toward one side of the terminal part; a second bobbin including a tubular body part and terminal parts and having the same shape as that of the first bobbin; and a core simultaneously coupled to the first and second bobbins.

The first and second bobbins may be coupled to each other to allow the body parts to be disposed adjacently thereto.

Portions of the core inserted into the body parts of the first and second bobbins and portions of the core exposed outwardly of the body parts of the first and second bobbins may have the same cross sectional area.

According to another aspect of the present invention, there is provided an electronic device, including: at least two light sources; and at least two light source driving units respectively connected to the at least two light sources to supply power thereto, wherein the light source driving units include respective coil parts transforming input voltage and the coil parts share a single core.

The light sources may include an LED array formed by connecting a plurality of LEDs to each other.

The light source driving units may include respective DC/DC converters.

According to another aspect of the present invention, there is provided an electronic device, including: a plurality of light sources; and a plurality of DC/DC converters respectively connected to the plurality of light sources to supply power, wherein at least two of the plurality of DC/DC converters are configured to allow respective coils to share a single core.

According to another aspect of the present invention, there is provided an electronic device, including: a plurality of light sources; and a plurality of DC/DC converters respectively connected to the plurality of light sources to supply power, wherein at least two of the plurality of DC/DC converters share a single coil component as described above to transform input voltage.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view schematically illustrating a coil component according to an embodiment of the present invention;

FIG. 2 is a perspective view of the coil component illustrated in FIG. 1, except a coil;

FIG. 3 is an exploded perspective view of the coil component illustrated in FIG. 2;

FIG. 4 is an exploded perspective view schematically illustrating a bobbin part of FIG. 1;

FIG. 5 is a perspective view illustrating a respective bobbin of the bobbin part of FIG. 4;

FIG. 6 is a cross-sectional view taken on line A-A′ of FIG. 2;

FIGS. 7 and 8 are cross-sectional views taken on line B-B′ of FIG. 1; and

FIG. 9 is a circuit diagram of an electronic device according to an embodiment of the present invention.

### DETAILED DESCRIPTION OF THE EMBODIMENTS

Hereinafter, embodiments of the present invention will be described in detail with reference to the accompanying drawings.

The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions of elements may be exaggerated for clarity, and the same or like reference numerals will be used throughout to designate the same or like elements.

FIG. 1 is a perspective view schematically illustrating a coil component according to an embodiment of the invention, FIG. 2 is a perspective view of the coil component illustrated in FIG. 1, except a coil, and FIG. 3 is an exploded perspective view of the coil component illustrated in FIG. 2.

FIG. 4 is an exploded perspective view schematically illustrating a bobbin part of FIG. 1 and FIG. 5 is a perspective view illustrating a respective bobbin of the bobbin part of FIG. 4.

Referring to FIGS. 1 through 5, a coil component 100 according to an embodiment of the invention may include a bobbin part 20, a coil 70, and a core 40.

As illustrated in FIG. 4, the bobbin part 20 may be configured of a plurality of bobbins 20a and 20b.

Further, as illustrated in FIGS. 4 and 5, each bobbin 20a and 20b may include a tubular body part 22 having a through hole 21 formed in a center thereof, flange parts 23 extending vertically in an outer diameter direction of the body part 22 from both ends of the body part 22, and terminal parts 25 extending from the flange parts 23.

The through hole 21 formed in the body part 22 is used as a path through which a portion of the core 40 is inserted. In the embodiment of the invention, a section of the through hole 21 has a quadrangular shape by way of example. The through hole 21 is configured to meet a shape of the core 40 inserted into the through hole 21, and the invention is not limited thereto. That is, the through hole 21 may have various shapes, corresponding to the shape of the core 40 inserted into the through hole 21.

The flange parts 23 may be respectively formed at both ends of the body part 22. In addition, a space formed between an outer circumferential surface of the body part 22 and the two flange parts 23 is used as a winding part 28, around which the coil 70 is wound. Therefore, the flange parts 23 may serve to protect the coil 70 from the outside and insulate the coil 70 from the outside, while supporting the coil 70 wound around the winding part 28.

In addition, the coil component 100 according to the embodiment of the invention includes a protrusion 27 formed on an outer surface of any one of the flange parts 23. The protrusion 27 may have a projection shape protruding outwardly from the outer surface of the flange part 23 and may be formed on the flange part 23 formed above the through hole 21 to be easily identified with the naked eye.

The protrusion 27 according to the embodiment of the invention is provided to allow a winding direction of the coil to be easily identified when the coil 70 is automatically (or manually) wound around the bobbin 20.

The terminal parts 25 may be formed to extend outwardly from both ends of the body part 22 of the bobbin 20, that is, the flange parts 23, respectively, and may be provided with one or more external connection terminals 60 fastened thereto.

Referring to FIGS. 4 and 5, the terminal part 25, according to the embodiment of the invention, may be extended from a portion of the inner surface of the body part 22 and may be formed to be approximately vertical with respect to the flange part 23.

Further, the terminal part 25 may not be disposed in a symmetrical manner based on the body part 22, but any one side of the terminal part 25 may be elongated, based on the body part 22. That is, in the bobbins 20a and 20b according to the embodiment of the invention, the body part 22 is not disposed at the center of the terminal part 25 and is instead disposed in a position toward any one side of the terminal part 25.

Ends of the terminal parts 25 may be provided with coupling projections 25a and insertion parts 25b. The coupling projections 25a and the insertion parts 25b are provided to couple the two bobbins 20a and 20b so as to be integrally formed. Therefore, when the two bobbins 20a and 20b are coupled, the coupling projections 25a may be inserted into the insertion parts 25b.

To this end, in the coil component 70 according to the embodiment of the invention, respective one ends of the terminal parts 25 may be provided with the coupling projection 25a and the insertion part 25b. Further, as illustrated in FIG. 4, both ends of the terminal parts 25 may be provided with the coupling projection 25a and the insertion part 25b. In this case, the bobbins 20a and 20b may be coupled to one another in various directions.

The external connection terminals 60 may be fastened to the terminal part 25 in a manner of being protruded outwardly from the terminal part 25.

In the embodiment of the invention, the external connection terminals 60 may be protruded downwardly from a lower surface of the terminal part 25, by way of example.

However, the invention is not limited thereto. That is, the external connection terminals 60 may be fastened to the side of the terminal part 25 so as to be horizontally protruded therefrom and portions of the external connection terminals 60 may be bent.

Further, as illustrated in FIGS. 3 and 5, the terminal part 25 according to the embodiment of the invention includes four external connection terminals 60. However, the invention is not limited thereto, and the number of external connection terminals 60 may be changed, corresponding to the number of coils 70.

The bobbin part 20 according to the embodiment of the invention may be integrally formed by coupling the two bobbins 20a and 20b to one another. In particular, the first and second bobbins 20a and 20b according to the embodiment of the invention may have the same shape.

The first and second bobbins 20a and 20b may be coupled while allowing the body parts 22 to be disposed in parallel. Referring to FIG. 4, the first and second bobbins 20a and 20b according to the embodiment of the invention are coupled such that the body parts 22 are disposed adjacently to each other. Further, the first and second bobbins 20a and 20b may be coupled in a manner in which the coupling projections 25a thereof are inserted into the corresponding insertion parts 25b.

As described above, as the first and second bobbins 20a and 20b are coupled, the respective body parts 22 are disposed in a central portion of the coil component 100 and spaces are provided outwardly of the body parts 22 by the protruded terminal parts 25.

Further, the spaces are provided to be occupied by outer legs 42a and 42b of the core 40 to be described below. Therefore, upper regions of the terminal parts 25 protruding from the body parts 22 are used as spaces for accommodating the outer legs 42a and 42b of the core 40 and a distance by which the terminal parts 25 protrude from the body parts 22 may correspond to a length (or thickness) of the outer legs 42a and 42b.

The bobbin part 20 may be manufactured by injection molding, but is not limited thereto. That is, the bobbin part 20 may also be manufactured by various methods, such as press processing, and the like. In addition, the bobbins 20a and 20b according to the embodiment of the invention may be formed of an insulating resin material and may be formed of a material having high heat resistance and high withstand voltage.

As a material for forming the bobbin part 20, polyphenylenesulfide (PPS), liquid crystal polyester (LCP), polybutyleneterephthalate (PBT), polyethyleneterephthalate (PET), phenolic resin, and the like, may be used.

The coils 70 may be wound around the winding parts 28 formed on the bobbins 20a and 20b.

The coil 70 may be a single strand of wire or a Ritz wire formed by twisting several strands of wire. A lead wire, an end of the coil 70 may be physically and electrically connected to the external connection terminal 60 protruded from the terminal part 25.

Meanwhile, in the coil component 100 according to the embodiment of the invention, the respective coils 70 may be wound around the two bobbins 20a and 20b in different directions (that is, opposite direction). For example, when one coil is wound around any one of the bobbins in a clockwise direction, the other coil may be wound around the other bobbin in a counterclockwise direction. However, the invention is not limited thereto, and therefore, if necessary, the coils may be wound in various manners, such as winding the coils in opposite directions, winding the coils in the same direction, and the like.

Further, the first and second bobbins 20a and 20b according to the embodiment of the invention have the respective coils 70 wound therearound. The coils 70 may be operated independently of each other through electromagnetic coupling with the core 40 to be described below. That is, the first bobbin 20a having the coil 70 wound therearound and the core 40 may be operated as a first coil part, and the second bobbin 20b having the coil 70 wound therearound and the core 40 may be operated as a second coil part independent of the first coil part.

The core 40 may be partially inserted into the through holes 21 formed in the bobbins 20a and 20b to form a magnetic path electromagnetically coupled to the coil 70.

The core 40 according to the embodiment of the invention may be provided in pair. Therefore, the pair of cores may be partially inserted into the through holes 11 of the bobbins to be coupled to each other.

The core 40 may be a ferrite core including a plurality of legs 41a, 41b, 42a and 42b, and may be used as a path of a magnetic field generated depending on a flow of current in the coil 70.

The pair of cores 40a and 40b may have the same shape and may be provided to be symmetrical with respect to each other. In this case, the manufacturing and assembly of the pair of cores 40a and 40b may be facilitated.

Further, the pair of cores 40a and 40b may respectively be configured to include inner legs 41a and 41b inserted into the bobbins 20a and 20b and the outer legs 42a and 42b disposed outwardly of the bobbin part 20. Further, the inner legs 41a and 41b and the outer legs 42a and 42b are connected by a connection part 43.

The inner legs 41a and 41b are inserted into the through holes 11 of the body parts 22. Therefore, sections of the inner legs 41a and 41b have shapes corresponding to sections of the through holes 21 and may be formed to have cross sectional areas smaller than those of the through holes 21 so as to facilitate the insertion of the inner legs thereinto.

In the embodiment of the invention, the through holes 21 have quadrangular sections. Therefore, the sectional shape of the inner legs 41a and 41b may be similar to the quadrangular shape.

Ends of the inner legs 41a and 41b may be provided to face each other in an approximately central position of the through holes 21, and as illustrated in FIG. 7, clearances 45 may be formed between the ends of the inner legs 41a and 41b facing each other.

The outer legs 42a and 42b may be disposed in parallel with the body parts 22 at the outside of the bobbin part 20. Further, the outer legs 42a and 42b according to the embodiment of the invention may be formed to have sections equal to or wider than those of the inner legs 41a and 41b.

In more detail, the outer legs 42a and 42b may be formed to surround the body parts 22 of the bobbins 20a and 20b.

The connection part 43 connects between the inner legs 41a and 41b and the outer legs 42a and 42b. Like the outer legs 42a and 42b, a section of the connection part 43 may be equal to or wider than the section of the inner legs 41a and 41b.

Further, a lower surface of the connection part 43 may be seated on an upper surface of the terminal part to thereby be supported by the terminal part.

The core 40 may be formed of Mn—Zn-based ferrite having higher permeability, lower loss, higher saturation magnetic flux density, higher stability, and lower production cost, as compared to other materials. However, the material of the core 40 is not particularly limited.

Meanwhile, in the embodiment of the invention, by way of example, the core 40 has a ‘ [symbol] ’-like shape and the inner legs 41a and 41b and the outer legs 42a and 42b are disposed in parallel. Therefore, the two bobbins 20a and 20b coupled to the core 40 may be disposed in parallel, while the body parts 22 being disposed in parallel.

In the coil component 100 according to the embodiment of the invention configured as described above, the two coil parts (L1 of FIG. 7 and L2 of FIG. 8) are configured as a single coil component. However, in case of configuring the coil component as described above, the two coil parts share a single core.

In this case, magnetic fluxes occurring in the core 40 due to respective coil parts may not be interfered with each other.

Therefore, in order to minimize the interference of the magnetic fluxes occurring in the core 40, the coil component according to the embodiment of the invention is configured such that all of the inner legs 41a and 41b, the outer legs 42a and 42b, and the connection part 43 have the same cross sectional area.

FIG. 6 is a cross-sectional view taken on line A-A′ of FIG. 2, and FIGS. 7 and 8 are cross-sectional views taken on line B-B′ of FIG. 1.

First, as illustrated in FIG. 6, cross sectional areas A2 and A3 of portions of the core inserted into the bobbins 20a and 20b need to be the same as cross sectional areas A1 and A4 of portions of the core disposed outwardly of the bobbins 20a and 20b to constantly maintain magnetic flux density within the core. To this end, the core 40 according to the embodiment of the invention may be configured such that all of the inner legs 41a and 41b, the outer legs 42a and 42b, and the connection part 43 have the same cross sectional area. Further, the clearance may be formed between the ends of the inner legs 41a and between the ends of the inner legs 41b.

In general, magnetic flux within the core 40 is formed along a path through which the magnetic flux flows most easily. In case of the magnetic flux formed by the first coil part L1, as illustrated in FIG. 7, a path may be formed in A, B, and C directions. However, in case of path B, the magnetic flux may be difficult to flow due to the clearance 45 between the inner legs, and in case of path C, the overall length of the path increases. Therefore, all magnetic fluxes formed by the first coil part L1 may flow in path A.

Similarly, in case of the magnetic flux formed by the second coil part L2, as illustrated in FIG. 8, a path may be formed in D, E, and F directions. However, in case of path E, the magnetic flux may be difficult to flow due to the clearance 45 between the inner legs, and in case of path F, the overall length of the path increases. Therefore, all magnetic fluxes formed by the second coil part L2 in the second bobbin 20b may flow in path D.

Here, as described above, the core 40 according to the embodiment of the invention may be configured such that all of the inner legs 41a and 41b, the outer legs 42a and 42b, and the connection part 43 have the same cross sectional area. Therefore, even in the case that the magnetic fluxes are simultaneously formed on paths A and D, the paths are independently formed without mutual interference and respective paths along which the magnetic fluxes are formed have the same cross sectional area, such that the magnetic fluxes may be maintained without the attenuation of the magnetic flux density.

As described above, in the coil component according to the embodiment of the invention, the magnetic flux formed by the first coil part may be formed on path A and the magnetic flux formed by the second coil part may be formed on path D, whereby the mutual interference of the two magnetic fluxes within the core may be prevented.

Therefore, in the coil component according to the embodiment of the invention, a coupling factor K between the magnetic flux formed by the first coil part and the magnetic flux formed by the second coil part within the same core may approximate ‘0’.

In a case in which interference between two magnetic fluxes occurs to thereby increase a coupling factor within a core, a time difference occurs in duties of two coil parts due to variation in loads of the coil parts and one coil thereof may be saturated for the time difference, such that the efficiency of the coil parts may be reduced.

However, in the coil component according to the embodiment of the invention, even in the case that the two coil parts use a single core, the coupling factor approximates ‘0’, such that no interference may occur in the magnetic fluxes formed by the two coil parts.

Therefore, even in the case that the two coil parts are configured of a single component, the coil component according to the embodiment of the invention may achieve the same efficiency as that of a coil component in which two coil parts are individually mounted as separate elements.

According to the embodiment of the invention configured as described above, two coil parts are configured in a single coil component and only a single core is used. Therefore, as compared with the related art coil component in which two coil parts are configured as separate elements, a space (or area) occupied by the coil component mounted on the substrate may be reduced.

Further, according to the embodiment of the invention, even in the case that the two coil parts are unified into a single component, the coupling factor within the core approximates ‘0’, and thus, the coil component can obtain the same efficiency as compared with the case in which two coil parts are configured as separate elements.

In addition, in the coil component according to the embodiment of the invention, the two bobbins coupled to the core have the same shape. Therefore, a kind of bobbin is manufactured in plural and then two of the plurality of manufactured bobbins are coupled to each other, and accordingly the coil component according to the embodiment of the invention can be manufactured. Therefore, manufacturing process may be facilitated and manufacturing costs may be reduced.

FIG. 9 is a circuit diagram of an electronic device according to an embodiment of the invention.

The electronic device in the present embodiment of the invention will be described using a display device. However, the electronic device is not limited thereto, but may include various kinds of lighting devices and all devices emitting light through light sources.

A display device 1 according to the embodiment of the invention may include a light source unit S supplying light to a liquid crystal panel and a light source driving unit supplying power to the light source unit S.

The light source unit S may include a light emitting diode (LED), driven using a DC power supply. The light source unit S may be configured of a plurality of light sources S1 and S2 and each of the light sources S1 and S2 may be configured of a single LED or a plurality of LEDs.

Further, each of the light sources S1 and S2 may have an array of LEDs mounted on a substrate. Here, the LED array is driven by driving power supplied from the light source driving unit and emits light by using the DC power having a voltage of a predetermined level or more.

The light source driving unit supplies power to the light source unit S. To this end, the light source driving unit may include DC/DC converters CV1 and CV2 converting input power into DC power suitable to drive the light source unit S.

The DC/DC converters CV1 and CV2 may be provided to correspond to the number of light sources S1 and S2. In the embodiment of the invention, the light source unit S includes two LED arrays S1 and S2. Therefore, two DC/DC converters CV1 and CV2 may be provided and thus connected to the LED arrays S1 and S2, respectively.

Meanwhile, the two DC/DC converters CV1 and CV2 have the same configuration, except that they are different in terms of the configuration of coil parts L1 and L2. Therefore, the same configuration will be described with reference to only a single DC/DC converter CV1.

The DC/DC converter CV1 is connected to a rectifying unit (not illustrated) or a power factor improving unit (not illustrated) to receive power Vin, and may include the coil part L1, that is, a transformer. Further, the DC/DC converter may include a switching element M1 and an output rectifying unit for rectification.

The switching element M1 is switched according to a switching signal transmitted from a control unit CU1 to control a flow of current from the coil part L1. Here, the switching element M1 may be a transistor.

The output rectifying unit may rectify AC voltage output from the coil part L1 into DC voltage to be supplied to the light source S1, that is, the LED array. To this end, the output rectifying unit may include a rectifying diode D1 and a smoothing capacitor C1. An anode of the rectifying diode D1 may be connected to one end of a secondary winding of the coil part L1. Further, one end of the smoothing capacitor C1 may be connected to a cathode of the rectifying diode D1 and the other end thereof may be connected to a ground.

Further, in the light source driving unit according to the embodiment of the invention, the two DC/DC converters CV1 and CV2 supplying power to the two light sources S1 and S2 may share a single core 40. That is, in the two DC/DC converters CV1 and CV2 respectively connected to the two light sources S1 and S2, respective coil parts L1 and L2 may be configured as a single coil component 100 and the coils 70 (FIG. 1) of the coil parts L1 and L2 may share a single core 40.

Such a configuration may be implemented by the use of the foregoing coil component 100 (FIG. 1). As described above, the coil component 100 according to the embodiment of the invention is configured to use only a single core 40 by forming two coil parts L1 (FIG. 7) and L2 (FIG. 8) in a single component. Further, the coil 70 of each coil part L1 and L2 shares a single core 40.

In case of using the coil component 100 according to the embodiment of the invention, a single coil component 100 may be used per two DC/DC converters CV1 and CV2.

In the related art, coil parts of DC/DC converters are individually configured of independent coil components. Therefore, when two DC/DC converters are configured, two coil components are needed and coils of the coil parts use separate, independent cores.

However, according to the embodiment of the invention, when a single coil component 100 is used with respect to two DC/DC converters CV1 and CV2 and the respective coils 70 are configured to share the single core 40, a space (or area) occupied by the coil component 100 mounted on the substrate may be reduced. Further, when only a single coil component 100 with respect to the two DC/DC converters CV1 and CV2 is mounted on the substrate during the manufacturing process, manufacturing time may also be reduced.

Meanwhile, FIG. 9 illustrates the case in which a single coil component is provided corresponding to the two light sources S1 and S2, but the electronic device according to the embodiment of the invention is not limited thereto. That is, in the case in which four light sources are included, two coil components may be used, and in the case in which eight light sources are included, four coil components may be used.

The coil component according to the present inventive concept is not limited to the above-mentioned embodiments, but may be variously modified. For example, two bobbins are horizontally disposed with respect to a mounting surface of a substrate in the foregoing embodiments, but the invention is not limited thereto. That is, the bobbins may be disposed in various manners, such as being vertically disposed with respect to the mounting surface of the substrate, being disposed at a specific angle, or the like.

Further, in the foregoing embodiment of the invention describes, the coil component is adopted in the light source driving unit, but the invention is not limited thereto. The coil component according to the embodiment of the invention may be applied to various electronic components and electronic devices.

As set forth above, in a coil component according to embodiments of the invention, two coil parts are configured in a single component and only a single core is used. Therefore, as compared with the related art in which two coil parts are configured as separate components, a space (or area) occupied by the coil component mounted on the substrate can be reduced.

Further, according to the embodiments of the invention, even in the case that two coil parts are unified into a single component, a coupling factor within the core approximates ‘0’, and thus the coil component can achieve the same efficiency as that of a coil component in which two coil parts are configured as separate components.

In addition, in the coil component according to the embodiments of the invention, two bobbins coupled to the core have the same shape. Therefore, the coil component can be manufactured by preparing a kind of bobbin in plural and then coupling two of the plurality of bobbins to each other. Therefore, the manufacturing process thereof may be facilitated and manufacturing costs may be reduced.

While the present invention has been shown and described in connection with the embodiments, it will be apparent to those skilled in the art that modifications and variations can be made without departing from the spirit and scope of the invention as defined by the appended claims.

What is claimed is:

1. A coil component, comprising:
a bobbin part including two body parts disposed in parallel, the two body parts having coils wound therearound; and
a core including two inner legs inserted into the body parts and two outer legs disposed outwardly of the body parts, the inner legs and the outer legs having the same cross sectional area.

2. The coil component of claim 1, wherein the core has the inner legs and the outer legs disposed in parallel.

3. The coil component of claim 2, wherein the core includes a connection part connecting the inner legs and the outer legs.

4. The coil component of claim 3, wherein the connection part of the core has the same cross sectional area as the inner leg and the outer leg.

5. The coil component of claim 1, wherein the core has a ‘ [symbol] ’-like shape.

6. The coil component of claim 1, wherein the core has a clearance formed between ends of the inner legs facing each other.

7. The coil component of claim 1, wherein the bobbin part is formed by coupling first and second bobbins to one another, the first and second bobbins having the same shape.

8. The coil component of claim 7, wherein each of the first and second bobbins includes:
the body part having a tubular shape; and
terminal parts formed at both ends of the body part, and
the body part is disposed in a position toward one side of the terminal part.

9. The coil component of claim 8, wherein the first and second bobbins are coupled to each other to allow the body parts to be disposed adjacently thereto.

10. The coil component of claim 8, wherein the core is seated on an upper surface of the terminal part and coupled to the bobbin part.

11. The coil component of claim 8, wherein the first and second bobbins have at least one protrusion and at least one insertion part formed on the terminal parts, and are coupled to each other by inserting the at least one protrusion into the at least one insertion part.

12. The coil component of claim 8, wherein the terminal parts are provided with a plurality of external connection terminals fastened thereto.

13. A coil component, comprising:
a first bobbin including a tubular body part and terminal parts formed at both ends of the body part and having a length greater than a diameter of the body part, the body part being disposed in a position toward one side of the terminal part;
a second bobbin including a tubular body part and terminal parts having the same shape as that of the first bobbin; and
a core simultaneously coupled to the first and second bobbins.

14. The coil component of claim 13, wherein the first and second bobbins are coupled to each other to allow the body parts to be disposed adjacently thereto.

15. The coil component of claim 13, wherein portions of the core inserted into the body parts of the first and second bobbins and portions of the core exposed outwardly of the body parts of the first and second bobbins have the same cross sectional area.

16. An electronic device, comprising:
at least two light sources; and
at least two light source driving units respectively connected to the at least two light sources to supply power thereto;
wherein the light source driving units include respective coil parts transforming input voltage, and
the coil parts share a single core.

17. The electronic device of claim 16, wherein the light sources include an LED array formed by connecting a plurality of LEDs to each other.

18. The electronic device of claim 16, wherein the light source driving units include respective DC/DC converters.
